(19) United States
(12) Patent Application Publication
(10) Pub. No.: US 2025/0264131 A1
(43) Pub. Date: Aug. 21, 2025

(54) SLIDING LAYER FOR FLUID-LUBRICATED PLAIN BEARINGS

(71) Applicant: AKTIEBOLAGET SKF, GOTEBORG (SE)

(72) Inventors: Andreas VIERLING, Schwebheim (DE); Stefan KELLER, Schweinfurt (DE)

(21) Appl. No.: 19/049,550

(22) Filed: Feb. 10, 2025

(30) Foreign Application Priority Data
Feb. 20, 2024 (DE) 102024201546.6

(51) Int. Cl. F16C 33/10

(52) U.S. Cl. CPC F16C 33/1095

(57) ABSTRACT

A fluid-lubricated plain bearing includes a bearing element, such as a tilting pad, having a sliding surface and a sliding layer connected to or formed on the sliding surface. The sliding layer includes a fiber composite material, and the fiber composite material includes a matrix and fibers embedded in the matrix. The fibers may include a lubricating fibers and reinforcing fibers and the fibers may be woven together.

### CROSS-REFERENCE

This application claims priority to German patent application no. 10 2024 201 546.6 filed on Feb. 20, 2024, the contents of which are fully incorporated herein by reference.

### TECHNOLOGICAL FIELD

The present disclosure is directed to a fluid-lubricated plain bearing, in particular a hydrodynamic plain bearing, having a sliding layer on a sliding surface.

### BACKGROUND

Fluid-lubricated plain bearings can be categorized into hydrodynamically lubricated and hydrostatically lubricated plain bearings. Hydrostatically lubricated plain bearings (hydrostatic plain bearings) operate on the principle of external pressure generation, meaning that the necessary lubricant pressure is produced outside the bearing by a pump.

Hydrodynamically lubricated plain bearings (hydrodynamic plain bearings) are plain bearings in which the lubricant film is generated by the rotational motion of the shaft/axis. Initially, the lubricant lies on the plain bearing. Upon starting, mixed friction initially occurs between the shaft and the bearing. As rotational motion increases, lubricant oil is supplied to the unloaded upper side and the pressure around the shaft increases. This raises the shaft, resulting in fluid friction and therefore a reduction in friction. In the case of hydrostatic plain bearings, the lubricant is supplied to the load-transmitting area by an external pump under the required pressure.

Hydrodynamic plain bearings can therefore be operated without wear, as long as a continuous lubricant film is present. Depending on the bearing geometry and operating conditions, the hydrodynamic lubricant film establishes itself automatically or forms as soon as the appropriate parameters are met. The sliding speed, among other things, plays a key role in the formation of a hydrodynamic lubricant film. However, during the start-up of a bearing from a stationary state or when stopping the bearing, the sliding speed is too low to form a hydrodynamic lubricant film. Without a lubricant film separating them, the two sliding surfaces come into direct contact, meaning the operation occurs under mixed or boundary friction. Due to insufficient lubrication, this phase of operation can result in significant damage, such as wear on the surfaces of the sliding partners.

### SUMMARY

An aspect of the present disclosure is therefore to improve the friction and wear characteristics during the start-up of a bearing from a stationary state or when stopping a bearing, i.e. when the sliding speed is too low to create or to maintain a hydrodynamic lubricant film.

In the following, a fluid-lubricated plain bearing is disclosed that comprises at least one bearing ring having a sliding surface. In order to reduce friction even when the bearing is stationary or during the start-up of the bearing, and to ensure minimal friction on the sliding surface in all operating conditions, it is further provided that a sliding layer is at least partially formed on the sliding surface, wherein the sliding layer is made of a fiber composite material that includes a matrix in which fibers are embedded.

The sliding layer itself may be connected to the at least one sliding surface of the tilting segment (when the plain bearing is a tilting-pad bearing) by means of an adhesive bond, for example, or it may be sprayed onto the sliding surface.

The presence of the sliding layer made of fiber composite material ensures that, at low sliding speeds—in particular during the start and stop phases—the sliding surfaces do not come into direct contact with one another, as a result of which wear on the surfaces of the sliding components of a plain bearing can be reduced. Overall, the durability and therefore the wear resistance and service life of the bearing are improved. Furthermore, the embedding of fibers in a matrix in the case of fiber composite materials provides support for the fibers, enhancing stiffness, strength, shear strength and wear resistance, which is particularly advantageous for start-up and stopping operations in fluid-lubricated plain bearings.

A weave of the fabric material can be selected based on the properties desired. For example, an ATLAS weave is particularly advantageous for sliding materials. This type of weave creates only a few intersections of warp and weft threads. As a result, the fabric is very flexible and smooth, making it suitable for complex geometries and generally low friction values. The weave also influences the distribution of components across the fabric thickness. For instance, it is advantageous to have a higher proportion of sliding components on the upper side and reinforcing fibers on the underside of the fabric. This allows wear and friction properties to be controlled or adjusted to some extent as wear progresses. Another option is so-called double weaving, in which, for example, an additional weft thread-either two identical or different weft materials, as desired-can be integrated. For instance, this could enable specific signals for wear or friction monitoring to be embedded across the fabric thickness, such as alternating weft threads with lower and higher friction, for example. As wear progresses, when the fiber with higher friction is reached, the driving force or torque required for movement, the bearing temperature or possibly even the noise level may increase. If these signals are detected using appropriate sensors, it becomes possible to identify bearing damage before the actual failure or breakthrough of the sliding layer occurs, allowing for timely intervention and replacement of the bearing.

The thickness of the sliding layer is preferably less than about 600 μm. With such a thickness it is possible to ensure that the sliding layer remains sufficiently hard to withstand the loads imposed by the plain bearing. On the other hand, if the thickness is too great, the plastics material, in particular the matrix material, e.g. the polymer, may become too soft and be unable to adequately support the component being borne.

According to a preferred exemplary embodiment, the fibers are designed as sliding fibers and made of a solid lubricant material and/or incorporate a solid lubricant, wherein, in particular, the fibers may include PTFE fibers, UHMWPE fibers, pitch-based carbon fibers, coated fibers made of reinforcing fiber materials and/or bi-component fibers. Using sliding fibers in the fiber composite material allows the sliding layer to be further optimized for friction. In this case, the use of PTFE fibers as a sliding fiber is particularly preferred. If the use of fluorine is to be avoided, UHMWPE fibers offer an alternative. Both materials exhibit exceptional sliding properties and can be easily formed into fibers.

According to another preferred exemplary embodiment, the fiber composite material includes, in addition or alternatively, reinforcing fibers, in particular continuous reinforcing fibers, as the fibers. This enhances the strength of the fiber composite material, as a result of which the stiffness, strength, shear strength and wear resistance of the composite material can in turn be increased. In particular, reinforcing fibers such as glass fibers, carbon fibers, PEEK fibers, polyester fibers, basalt fibers, PPS fibers, PA fibers, PLA fibers, PAI fibers, cotton fibers and/or sisal fibers can be used.

Pitch-based carbon fibers are particularly preferred as sliding and/or reinforcing fibers because, in addition to mechanical strength, they also exhibit lubricating properties. Alternatively or in addition, PEEK can be used, as it is particularly chemically resistant and does not absorb water, which is particularly important when oil is used as the fluid for the hydrodynamic plain bearing. Moreover, PEEK is also thermally stable, a significant advantage given the anticipated operating temperatures of the bearing. In addition, PEEK exhibits good sliding properties and can be easily formed into fibers.

Furthermore, it is advantageous for the fibers-whether sliding or reinforcing fibers-to be designed as continuous fibers that preferably form a fabric structure. In a preferred embodiment, the planar structure comprises both continuous reinforcing fibers and continuous sliding fibers which are preferably interwoven in the fabric. The interweaving of continuous fibers in the planar structure ensures high shear strength for the composite material and an even distribution of the solid lubricant, wherein excessive wear of the friction-reducing fiber or solid lubricant is also prevented.

According to another advantageous exemplary embodiment, the planar structure may be a laid fabric, a knitted fabric or a woven fabric. A sliding fabric is particularly preferred. The advantage of a sliding fabric is that it can be applied in very thin layers with smooth surfaces. This has the advantage that geometric irregularities are minimal.

Furthermore, the continuous fibers can be either single-filament or multi-filament yarns. Single-filament yarns are thicker and therefore more wear-resistant. The titer (linear density) of the single-or multi-filament yarns can range from 20 to 600 dtex. Preferably, the multi-filament yarns are formed of individual filaments with diameters ranging from 10 to 50 μm.

This configuration enables the creation of a stiff and strong fabric capable of withstanding the stresses of the plain bearing application.

Multi-filament yarns may also be formed from various fiber materials. Likewise, the individual fibers may also be made of different materials. Hence, for example, a coated fiber can also be used as the single fiber. Fibers of this kind may be present as a single filament, but they can also be used in multi-filament yarns. This offers the advantage that the best possible properties of the yarn for its intended use can be achieved. Multi-filament yarns may be entangled or twisted.

In another preferred exemplary embodiment, the fiber composite matrix contains an embedded solid lubricant, wherein the solid lubricant is preferably selected from the group consisting of PTFE, MoS₂, graphite, graphene, carbon nanotubes, WS₂, h-BN, MgSt-D and UHMWPE. The friction of the sliding layer can thereby be further reduced.

It is in particular preferred if the solid lubricant is embedded in the matrix as a powder or particles and/or in the form of fibers—in particular short fibers. This leads to an even distribution of the solid lubricant within the composite material, which in turn leads to a stabilization of the composite. When the solid lubricant is embedded in the matrix in the form of fibers, the fiber composite material is thereby simultaneously reinforced.

According to another preferred exemplary embodiment, the matrix comprises a thermoset or a thermoplastic material, preferably selected from the group consisting of epoxy resin, phenolic resin, polyurethane, PEEK, PEK, PI, PPS, PEI, POM, PA, PAI and PBI. This allows for a flexible plastic matrix with a high wear resistance capability to be provided.

Particularly preferably, epoxy resin is used as the matrix material due to its low water absorption and very high thermal stability. Furthermore, it exhibits excellent mechanical load-bearing capacity, enabling it to withstand the loads of the plain bearing application.

According to another preferred exemplary embodiment, the sliding layer is attached by means of an adhesive bond based on a thermosetting resin. This ensures a robust connection between the plain bearing and the sliding layer, capable of withstanding the anticipated operating temperatures while providing suitable durability, strength and curing properties.

According to another advantageous exemplary embodiment, the sliding layer can be applied to a raceway of the plain bearing. The plain bearing is preferably a hydrodynamic plain bearing.

A particularly preferred exemplary embodiment is one in which the plain bearing is a tilting-pad bearing, and the sliding layer is at least partially formed on at least one tilting pad. The tilting-pad bearing may be configured as a hydrodynamic tilting-pad bearing, with the sliding layer applied to the raceway of the hydrodynamic tilting pad. This configuration enables the plain bearing to be utilized for the most demanding applications too, such as in wind turbines, for example. The tilting-pad bearing preferably features at least eight tilting pads distributed around the circumference, wherein the sliding layer is formed on each pad.

Further advantages and advantageous embodiments are specified in the description, drawings and claims. In this case, the combinations of features indicated in the description and shown in the drawings are purely exemplary, meaning that the features can also exist individually or in other combinations.

### BRIEF DESCRIPTION OF THE DRAWINGS

The disclosure is further described below using exemplary embodiments illustrated in the figures. In this case, the exemplary embodiments and the combinations shown in the exemplary embodiments are purely illustrative and are not intended to define the scope of the invention. The scope is determined solely by the dependent claims.

FIG. 1A is a schematic sectional elevational view of a fluid-lubricated plain bearing according to an exemplary embodiment of the present disclosure.

FIG. 1B is a schematic elevational view of one of the sliding pad of FIG. 1A with a sliding layer applied thereto.

FIG. 2A is a plan view of a sliding layer usable in the bearing of FIG. 1A

FIG. 2B is sectional view through the sliding layer of FIG. 2A.

### DETAILED DESCRIPTION

In the following, identical or functionally equivalent elements are denoted using the same reference signs.

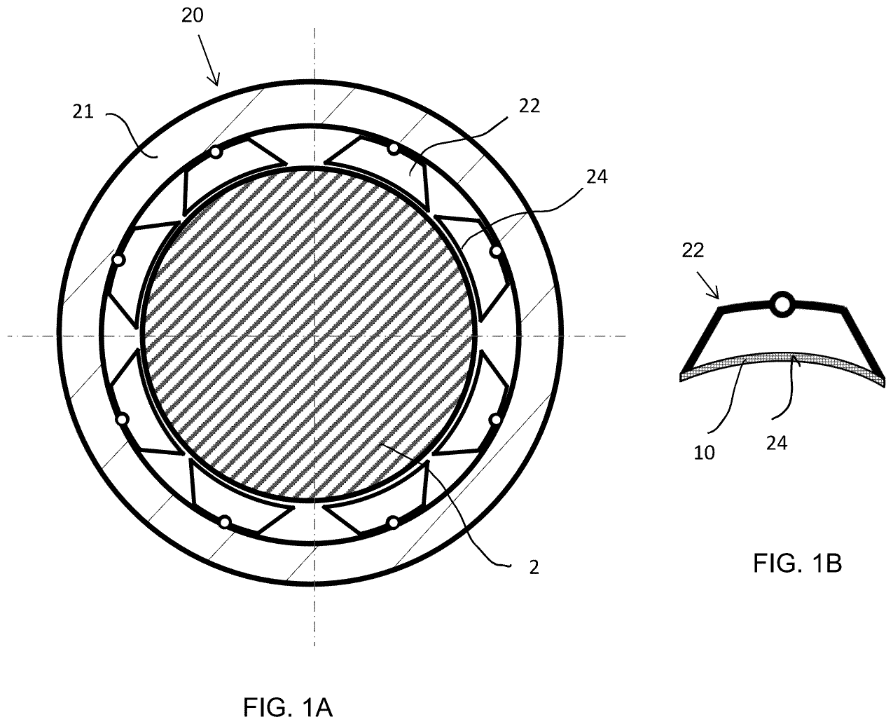

FIG. 1A schematically shows a fluid-lubricated plain bearing which in the exemplary embodiment shown here is configured as a tilting-pad bearing 20. The depicted tilting-pad bearing 20 is configured to radially support a component 2 and includes a bearing ring 21 carrying a plurality of circumferentially distributed radially supporting tilting pads 22. The tilting pads 22 have hydrodynamic sliding surfaces 24 (see detail in FIG. 1B) that rest against the component 2 when the bearing is in the stationary state. Furthermore, the tilting-pad bearing 20 is configured as a fluid-lubricated, in particular hydrodynamic, plain bearing and includes lubrication supply openings (not shown) through which a fluid lubricant is delivered to the hydrodynamic sliding surfaces 24. In this case, during normal operation, the lubricant film generated by the fluid lubricant on the sliding surfaces 24 ensures that the component 2 being supported “floats” on the lubricant film. However, a minimum rotational speed is required for this effect. To guarantee minimal possible friction at the sliding surfaces 24 during start-up or at low rotational speeds, even before a hydrodynamic lubricant film has been able to form, the tilting pads 22, as shown in FIG. 1B, feature a sliding layer 10 on the sliding surfaces 24. The sliding layer 10 is designed as a coating made of a fiber-reinforced composite material which may comprise a plastic matrix in which fibers are embedded.

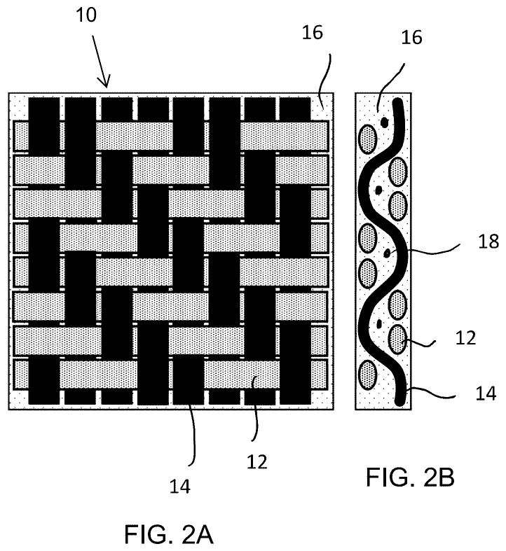

FIGS. 2A and 2B schematically illustrate a sliding layer 10 of this kind that may be applied to the hydrodynamic sliding surface 24 of the tilting pads 22. The sliding layer 10, as illustrated in FIGS. 2A and 2B, comprises a fabric, also known as a sliding fabric, made of sliding fibers 12 and reinforcing fibers 14, embedded in a plastic matrix 16 composed of a matrix material. The sliding fibers 12 and reinforcing fibers 14 are preferably formed as continuous fibers, wherein the sliding fibers 12 are woven around the reinforcing fibers 14. An ATLAS weave is preferably selected in this case, in which at least two fibers are always covered by an intersecting fiber. This minimizes the number of intersections between the fibers being woven, providing a fabric with a particularly smooth surface. The intersection of the sliding fibers 12 and reinforcing fibers 14, both configured as continuous fibers in this case, in the fabric ensures high shear strength of the sliding layer. Overall, the sliding fabric is very thin and exhibits a very smooth surface.

The sliding fibers 12 are specifically fibers made of a solid lubricant, including in particular PTFE fibers, UHMWPE fibers, pitch-based carbon fibers, coated fibers made of reinforcing fiber materials and/or bi-component fibers.

The reinforcing fibers 14 may comprise, for example, glass fibers, carbon fibers, PEEK fibers, polyester fibers, basalt fibers, PPS fibers, PA fibers, PLA fibers, PAI fibers, cotton fibers and/or sisal fibers.

The plastic matrix 16 is preferably a flexible plastic matrix which may be made from resin that is a thermoset and/or thermoplastic selected from the group consisting of epoxy resin, phenolic resin, polyurethane, PEEK, PEK, PI, PPS, PEI, POM, PA, PAI and PBI. The plastic matrix 16 can support the fibers and enhance the stiffness, strength, shear strength and wear resistance of the fabric. This results in a high-strength composite material with outstanding sliding properties.

Furthermore, as illustrated in FIG. 2B, solid lubricant particles 18 can be incorporated into the fabric, further reducing the friction resistance of the sliding layer. The solid lubricant may include molybdenum disulfide (MoS₂), graphite, graphene, carbon nanotubes, tungsten disulfide (WS₂), hexagonal boron nitride (h-BN) and/or magnesium stearate dihydrate (MgSt-D). With the help of the fabric made of sliding fibers 12 and reinforcing fibers 14, a uniform distribution of the solid lubricant particles 18 can be achieved, preventing excessive wear of the friction-reducing fibers or solid lubricant. This, in turn, ensures high wear resistance of the sliding layer 10 and therefore of the plain bearing 2.

Overall, with the fluid-lubricated plain bearing having a sliding layer made of fiber-reinforced material, the durability and therefore the wear resistance and service life of the fluid-lubricated plain bearing can be increased. In addition, maintenance intervals can be extended, CO₂ emissions reduced. Moreover, the risk of bearing failure is also minimized.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved plain bearings and sliding layers for plain bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

2 plain bearing
10 sliding layer
12 sliding fibers
14 reinforcing fibers
16 plastic matrix
18 solid lubricant particles
20 tilting-pad bearing
21 bearing ring
22 tilting pad
24 sliding surface

What is claimed is:

1. A fluid-lubricated plain bearing comprising:
at least one bearing element having a sliding surface,
wherein a sliding layer is connected to or formed on the sliding surface,
wherein the sliding layer comprises a fiber composite material, and
wherein the fiber composite material comprises a matrix and fibers embedded in the matrix.

2. The fluid-lubricated plain bearing according to claim 1,
wherein a first subset of the fibers comprise a solid lubricant material.

3. The fluid-lubricated plain bearing according to claim 1,
wherein a first subset of the fibers comprise PTFE fibers, UHMWPE fibers, pitch-based carbon fibers, coated fibers made of reinforcing fiber materials and/or bi-component fibers.

4. The fluid-lubricated plain bearing according to claim 3,
wherein a second subset of the fibers comprise reinforcing fibers.

5. The fluid-lubricated plain bearing according to claim 4,
wherein the reinforcing fibers are continuous fibers.

6. The fluid-lubricated plain bearing according to claim 5,
wherein the reinforcing fibers comprise glass fibers, carbon fibers, PEEK fibers, polyester fibers, basalt fibers, PPS fibers, PA fibers, PLA fibers, PAI fibers, cotton fibers and/or sisal fibers.

7. The fluid-lubricated plain bearing according to claim 1,
wherein the fibers are continuous fibers.

8. The fluid-lubricated plain bearing according to claim 7,
wherein the fibers form a sheet structure.

9. The fluid-lubricated plain bearing according to claim 1,
wherein the matrix of the fiber composite material comprises a solid lubricant selected from the group consisting of PTFE, MoS₂, graphite, graphene, carbon nanotubes, WS₂, h-BN, MgSt-D and UHMWPE.

10. The fluid-lubricated plain bearing according to claim 9,
wherein the solid lubricant comprises solid lubricant particles embedded in the matrix, and/or
wherein the solid lubricant comprises solid lubricant fibers embedded in the matrix.

11. The fluid-lubricated plain bearing according to claim 1,
wherein the matrix comprises a thermoset or a thermoplastic selected from the group consisting of epoxy resin, phenolic resin, polyurethane, PEEK, PEK, PI, PPS, PEI, POM, PA, PAI and PBI.

12. The fluid-lubricated plain bearing according to claim 1, wherein the sliding layer is attached to the sliding surface by an adhesive.

13. The fluid-lubricated plain bearing according to claim 1, wherein the sliding layer is attached to the sliding surface by an adhesive bond based on a thermosetting resin.

14. The fluid-lubricated plain bearing according to claim 1,
wherein the at least one bearing element comprises at least one tilting pad and wherein the sliding layer is formed on at least one portion of the at least one tilting pad.

15. The fluid-lubricated plain bearing according to claim 1,
wherein the at least one bearing element comprises at least one tilting pad,
wherein a first subset of the fibers comprise a solid lubricant,
wherein a second subset of the fibers comprise reinforcing fibers,
wherein the first subset of the fibers is selected from the group consisting of PTFE fibers, UHMWPE fibers, pitch-based carbon fibers, coated fibers made of reinforcing fiber materials and/or bi-component fibers,
wherein a second subset of the fibers is selected from the group consisting of glass fibers, carbon fibers, PEEK fibers, polyester fibers, basalt fibers, PPS fibers, PA fibers, PLA fibers, PAI fibers, cotton fibers and/or sisal fibers,
wherein the matrix comprises a thermoset or a thermoplastic selected from the group consisting of epoxy resin, phenolic resin, polyurethane, PEEK, PEK, PI, PPS, PEI, POM, PA, PAI and PBI, and
wherein the matrix comprises a solid lubricant selected from the group consisting of PTFE, MoS₂, graphite, graphene, carbon nanotubes, WS₂, h-BN, MgSt-D and UHMWPE.

16. The fluid-lubricated plain bearing according to claim 15,
wherein the fibers of the first subset of the fibers are woven with the fibers of the second subset of fibers.

17. The fluid-lubricated plain bearing according to claim 1,
wherein the fibers of the first subset of the fibers are woven with the fibers of the second subset of fibers.

18. The fluid-lubricated plain bearing according to claim 17,
wherein the matrix comprises an epoxy resin.

19. The fluid-lubricated plain bearing according to claim 18,
including a ring and a shaft,
wherein the at least one bearing element comprises a plurality of tilting pads mounted in a circumferentially spaced manner around an interior of the ring, and
wherein the shaft is supported by at least a subset of the plurality of tilting pads.

20. The fluid-lubricated plain bearing according to claim 1,
including a ring and a shaft,
wherein the at least one bearing element comprises a plurality of tilting pads mounted in a circumferentially spaced manner around an interior of the ring, and
wherein the shaft is supported by at least a subset of the plurality of tilting pads.
